(19) United States
(12) Patent Application Publication
(10) Pub. No.: US 2023/0289740 A1
(43) Pub. Date: Sep. 14, 2023

(54) MANAGEMENT OF IN ROOM MEETING PARTICIPANT

(71) Applicant: Microsoft Technology Licensing, LLC, Redmond, WA (US)

(72) Inventors: Carlos Cuadra De Pano, Markham (CA); Sushma Uppala, Sammamish, WA (US); Gaurav Pancholi, Redmond, WA (US); Varun Sundharbabu, Edgewood, WA (US); Nagaswapna Bhamidipati, Redmond, WA (US)

(21) Appl. No.: 17/692,895

(22) Filed: Mar. 11, 2022

(51) Int. Cl. G06Q 10/10; H04L 51/00; G06V 40/16; G06V 20/52

(52) U.S. Cl. CPC G06Q 10/1095; H04L 51/16; G06V 40/172; G06V 20/52

(57) ABSTRACT

A method and system for managing a message thread associated with a hybrid meeting are disclosed, comprising identifying a first in-room attendee of the hybrid meeting in a physical meeting space, detecting connection of a meeting application executed on a first user device of the first in-room attendee to a meeting service, without the meeting application having joined the hybrid meeting, and in response to identifying the first in-room attendee in the physical meeting space and detecting connection of the meeting application executed on the first user device of the first in-room attendee to the meeting service, without the meeting application having joined the hybrid meeting, sending an instance of the message thread associated with the hybrid meeting to the meeting application executed on the first user device of the first in-room attendee.

### TECHNICAL FIELD

The present disclosure generally refers to hybrid meeting management and more particularly to management of in-room meeting participants in accordance with some embodiments.

### BACKGROUND

Hybrid meeting environments provide meeting services, including audio, video, and screen sharing capabilities, to bring together combinations of in-room attendees at a physical meeting space, such as a conference room, and virtual attendees remote from the physical meeting space, for a shared meeting experience.

### SUMMARY

Embodiments of the present disclosure include a method and system for managing a message thread associated with a hybrid meeting, the hybrid meeting providing the capability for in-room attendance at a physical meeting space through a conference system and virtual attendance through one or more user devices. The method and system can include identifying a first in-room attendee of the hybrid meeting in the physical meeting space and detecting connection of a meeting application executed on a first user device of the first in-room attendee to a meeting service, without the meeting application having joined the hybrid meeting. In response to identifying the first in-room attendee in the physical meeting space and detecting connection of the meeting application executed on the first user device of the first in-room attendee to the meeting service, without the meeting application having joined the hybrid meeting, sending an instance of the message thread associated with the hybrid meeting to the meeting application executed on the first user device of the first in-room attendee.

The claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media (i.e., not storage media) may additionally include communication media such as transmission media for wireless signals, etc.

This Summary is provided to introduce a selection of concepts that are further described below in the Detailed Description. It is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The disclosed aspects will hereinafter be described in connection with the appended drawings that are provided to illustrate and not to limit the disclosed aspects.

FIG. 1 illustrates an example computer system for providing a communication stream between users.

FIG. 2 illustrates an example hybrid meeting including in-room meeting attendees and virtual meeting attendees.

FIG. 3 illustrates an example message thread between attendees of a hybrid meeting on a meeting application executed on a user device.

FIG. 4 illustrates an example method for managing a message thread associated with a hybrid meeting.

FIG. 5 illustrates an example method of mapping in-room attendees to a physical meeting space and merging first and second identifications of an in-room attendee.

FIG. 6 illustrates an example system comprising a user device coupled to a network.

FIG. 7 illustrates an example networking environment including one or more user devices, a conference system, and a meeting service system communicating over a network.

### DETAILED DESCRIPTION

Physical meeting spaces can include conference systems having one or more cameras, microphones, or combinations thereof, to capture audio or video of in-room attendees at the physical meeting space to be presented to, or with, remote attendees of a hybrid meeting. In certain examples, conference systems can recognize identities of in-room attendees in the physical meeting space using one or more recognition technologies (e.g., facial recognition, device recognition, etc.) implemented by the conference system, using one or more components accessible over a network, or combinations thereof.

However, a technical problem exists in tracking, connecting, and providing services for identified in-room attendees at the physical meeting space. The present inventors have recognized, among other things, a need to improve management of meeting rosters and services associated with a hybrid meeting environment, including messaging, communication, content distribution, feedback, etc.

Text communication, in particular, such as through instant messaging, text messaging, chat applications, email communications, etc., has become a primary way of communication. Text communication with meeting participants of a hybrid meeting is typically available during the hybrid meeting through electronic devices connected to a meeting application associated with the conference system and after having joined the hybrid meeting. Participation for meeting participants not having joined the hybrid meeting through the meeting application is difficult, and may require the meeting participant to start a separate, possibly redundant communication thread, mimicking that available to those having joined the hybrid meeting through the meeting application, an increasingly difficult and time consuming task, distracting the focus of the meeting participant from the hybrid meeting, potentially providing redundant communication with other meeting participants, or requiring the meeting participant to join the hybrid meeting at a potentially substantial cost to the electronic device and system resources in terms of battery use, network data use, screen use, and processing resources.

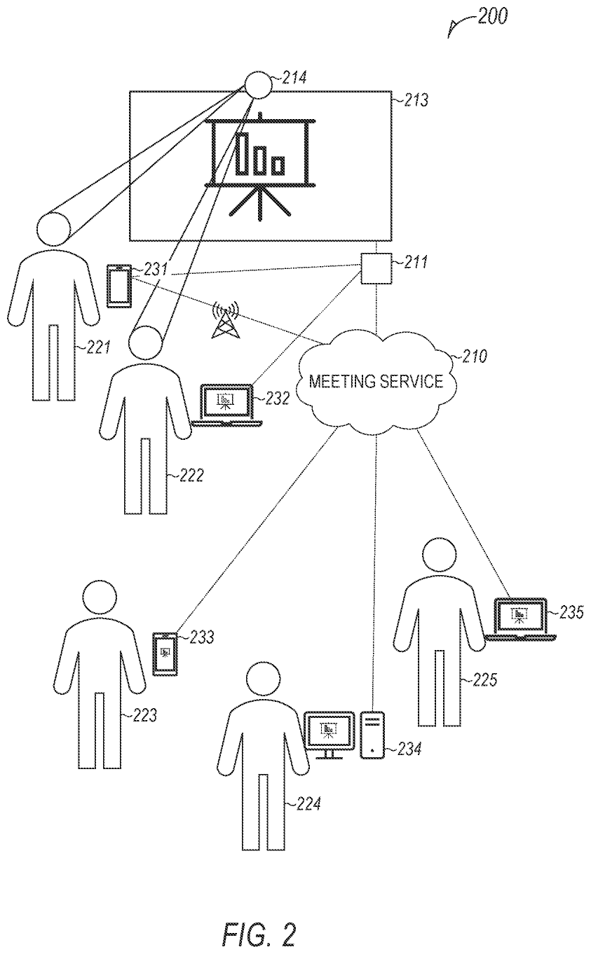

A technical solution contemplated herein provides an automated, rule-based system for identifying in-room attendees of a hybrid meeting in a physical meeting space (e.g., assigning respective identifications), detecting connection of a meeting application executed on a first user device of the first in-room attendee to a meeting service managing the hybrid meeting, without the meeting application having joined the hybrid meeting, and sending an instance of a message thread associated with the hybrid meeting to the meeting application executed on the first user device, such as to allow the in-room attendee to participate in the message thread for the hybrid meeting without joining the hybrid meeting on the first user device. There are different ways for attendees to participate in the hybrid meeting. The meeting service can manage each participant differently, for example, using a different mode of management and connection, depending on the way that the meeting attendee is determined to be participating. In this way, the meeting service transitions between management modes for different users participating in different ways, such as discussed and illustrated in FIG. 2.

In addition, a further technical solution contemplated herein provides automatic, dynamic roster management for the hybrid meeting environment, including preparing and providing a meeting roster to subscribed or authorized users or clients having an interest in the meeting roster and activities and changes associated with meeting attendees, such as tracking, connecting, and providing services for identified attendees in physical attendance at the physical meeting space. In an example, identified in-room attendees can be automatically assigned a participant ID corresponding to the identification (e.g., in metadata), added to the meeting roster (if not already included, such as through an invitation, etc.), and mapped to the physical meeting space or a component of the physical meeting space (e.g., mapped to a specific camera view in the physical meeting space, such as using a mapped field in the metadata, etc.). Meeting identities of in-room attendees also in virtual attendance, joining the hybrid meeting using meeting applications executed on one or more user devices in the physical meeting space, can be merged and mapped to a single identity in the physical meeting room. Notification of unidentified attendees can be provided to a meeting organizer, such as to allow the meeting organizer to selectively control access to sensitive information. Such merge and mappings can track movement of meeting participants into, about, and out of physical meeting spaces, between different cameras or camera views, participating with different user devices (e.g., removing or adding during the meeting, etc.), joining via one or more desktop, mobile, or web applications, etc.

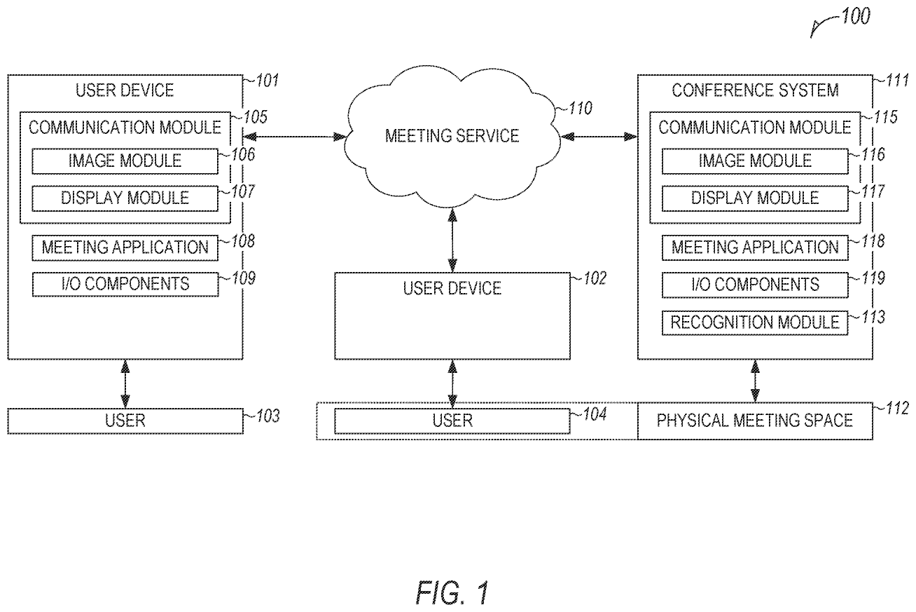

FIG. 1 illustrates an example system 100 including a meeting service 110 for managing a message thread associated with a hybrid meeting with in-room attendees at a physical meeting space 112 with a conference system 111, virtual attendees remote from the physical meeting space 112, or combinations thereof.

A first user 103 can be connected to the meeting service 110 and view or participate in the hybrid meeting as a virtual attendee, such as using a meeting application 108 executed on a first user device 101 (e.g., a mobile phone, laptop computer, desktop computer, or one or more other electronic devices) and connected to the meeting service 110. A second user 104 can be at the physical meeting space 112 and participate or view the hybrid meeting as an in-room attendee, such as through the conference system 111. In certain examples, the second user 104 can additionally view or participate in the hybrid meeting as a virtual attendee, such as using a meeting application executed on a second user device 102 connected to the meeting service 110. In such examples, the second user 104 is both an in-room attendee and a virtual attendee, able to view or participate in the hybrid meeting both through the conference system 111 in the physical meeting space 112 and virtually through the second user device 102.

Virtual attendees of the hybrid meeting, joining the meeting directly through respective user devices or having physical access to or control of the conference system 111, can access the message thread associated with the hybrid meeting managed by the meeting service 110, such as through a meeting application connected to the meeting service 110 of the respective user device or conference system 111. However, in-room attendees of the hybrid meeting, such as audience members in the physical meeting space 112 without direct physical access to or control of the conference system 111 or without having joined the hybrid meeting using a meeting application on a respective user device, do not have access to the message thread.

In certain examples, the meeting application 108 can include a client installed on a respective user device or conference system 111, such as a Microsoft Teams client, a Skype client, etc., and connected to the meeting service 110, such as a cloud-based meeting service or platform (e.g., Microsoft Teams, Skype, etc.). The meeting service 110 can manage communication streams, including emails, documents, chats, comments, texts, images, animations, hyperlinks, or voice or video communication for users associated with one or more online or hybrid meetings through meeting applications executed on connected devices, such as the first and second user devices 101, 102, the conference system 111, or one or more other devices including hardware and software configured to enable meeting applications or one or more other communication platforms to communicate to or from the respective devices.

The first user device 101 is exemplary of user devices (e.g., the second user device 102, etc.), and can include a communication module 105 configured to communicate with one or more additional devices, such as the second user device 102, either directly or through the meeting service 110, such as through the meeting application 108. The communication module 105 can be configured to send or receive information to or from the meeting service 110. The communication module 105 can include an image module 106, a display module 107 or one or more other modules configured to adapt data for communication to a user or for transmission to one or more other devices. The image module 106 can be configured to send, receive, or store images associated with the meeting service 110. In certain examples, the images can include icons, such as emojis, representations of emotions (e.g., emoticons), pictures, drawings, avatars, profile pictures, representations of one or more users, etc. In certain examples, the image module 106 can include a repository of images of the first user device 101 or otherwise associated with the first user 103 (e.g., cloud-based storage, online profiles, etc.). The display module 107 can be configured to display messages and other visual content associated with the communication module 105, such as using one or more input/output (I/O) components 109 or portions thereof, such as a display or portion of a display of the first user device 101. The I/O components 109 can include one or more of a display, keyboard, mouse, touch-screen input, camera, microphone, speaker, etc.

The conference system 111 is exemplary and can include components to present, display, and manage a hybrid meeting in the physical meeting space 112, including corresponding components to those discussed above with respect to the first user device 101, such as a communication module 115 configured to send or receive information to or from the meeting service 110, an image module 116 configured to send, receive, or store images associated with the meeting service 110, a display module 117 configured to display messages and other visual content associated with the communication module 105, a meeting application 118 executed on the conference system 111 and connected to the meeting service 110, I/O components 119 including one or more of a display, keyboard, mouse, touch-screen input, camera, microphone, speaker, etc. In an example, the conference system 111 can include a user device, such as the first user device 101 executing the meeting application 108, where the I/O components 119 of the conference system are respective 1/O components 109 of the first user device 101.

In addition to the corresponding components discussed above with respect to the first user device 101, the conference system 111 can include a recognition module 113 configured to identify or aid in identification of one or more in-room attendees of the hybrid meeting in the physical meeting space 112. In certain examples, the conference system 111 can be configured to capture one or more physical identifying features of in-room attendees of the physical meeting space 112, such as one or more of voice information or visual information of the in-room attendees. In an example, the recognition module 113 can be configured to perform recognition of the physical identifying features to identify an in-room attendee. In other examples, the conference system 111 can be configured to capture one or more physical identifying features and provide such features or information about such features, for example, determined by the recognition module 113, to one or more recognition components of the meeting service 110 or one or more other internet or cloud-based recognition services of, associated with, or available to the meeting service 110. Metadata including an identification of the in-room attendee can be created, such as by the recognition module 113 or one or more components of the meeting service 110, and provided to different aspects of the meeting service 110, such as to identify participants, speakers, etc. For example, the conference system 111 can capture an image of the physical meeting space and provide the image to the meeting service 110 for recognition of the one or more in-room attendees. In certain examples, the meeting service 110 can be configured to receive identification (e.g., metadata) of one or more in-room attendees of the hybrid meeting at the physical meeting space 112. The received information can be used to, among other things, perform roster management, provide updates to organizers or participants, etc.

In other examples, the conference system 111 can detect proximity of one or more user devices to the conference system 111, such as using one or more transceivers of the conference system 111 and the one or more user devices, a shared internet access point, or one or more other indications of proximity of respective devices. If a device is located in the physical meeting space and executing the meeting application associated with the meeting service 110 or the hybrid meeting, the conference system 111 can determine that the user associated with the meeting application is an in-person attendee at the physical meeting space 112. In other examples, the meeting service 110 can receive or determine a location of a user device executing a meeting application and determine that the user associated with the meeting application is an attendee of a hybrid meeting if the location of the user device corresponds to a location of the conference system or the physical meeting space. In certain examples, an indication of close proximity can trigger a request for confirmation from a user, such as through the meeting application of the user device.

FIG. 2 illustrates an example hybrid meeting environment 200 including a combination of in-room meeting attendees and virtual meeting attendees. In the example of FIG. 2, first and second meeting attendees 221, 222 are in-room meeting attendees participating in a hybrid meeting from a physical meeting space, such as a conference room, and viewing a display 213 and in view of a camera 214 of a conference system 211 coupled to a meeting service 210, such as through the internet. Third, fourth, and fifth meeting attendees 223, 224, 225 are virtual meeting attendees, participating in the hybrid meeting at locations remote from the physical meeting space through meeting applications executed on respective third, fourth, and fifth user devices 233, 234, 235 and connected to the meeting service 210. The first and second meeting attendees 221, 222 can optionally participate in the hybrid meeting as in-room and virtual meeting attendees by joining the hybrid meeting through meeting applications executed on respective first and second user devices 231, 232 and connected to the meeting service 210.

The conference system 211 can optionally include the display 213, or multiple displays, in the physical meeting space configured to display presentation material for the hybrid meeting, representations of one or more attendees (e.g., a selectable one or more audience members, speakers, meeting organizers, etc.), or combinations thereof. In other examples, the display 213 is not required for the physical meeting space, for example, in conference settings where a stage of presenters is the focus of in-room attendees, etc.

The conference system 211 can optionally include the camera 214, or multiple cameras, in the physical meeting space. In certain examples, the camera 214 can include or be one component of an intelligent camera system, such as alone or in combination with one or more services or applications of the conference system 211 or the meeting service 210, configured to create real and simulated camera angles, frames, or feeds for different meeting attendees, such as for display on the display 213 or on one or more user devices of other meeting attendees, to create a more immersive hybrid meeting environment.

In an example, the meeting service 210, or aspects of the meeting service 210 operating on the conference system 211 or through a meeting application executed on the conference system 211, can be configured to identify in-room attendees of the hybrid meeting using facial recognition, voice recognition, device detection, or combinations thereof, in certain examples in addition to or separate from registered or enrolled users of a scheduled meeting. Different individuals in the physical meeting space can be detected using analysis of images of the physical meeting space, such as captured using the camera 214. Devices in the physical meeting space executing a meeting application associated with the meeting service 210 can be detected in the physical meeting space, such as using a received or detected location of the devices, or a detected proximity to a component of the conference system 211. Locations of devices joining the hybrid meeting, such as user devices of virtual attendees remote from the physical meeting space or in-room attendees, can be received or determined. Identities of the detected in-room attendees can be assigned and mapped to the physical meeting space. In addition, identities of in-room attendees can be merged with corresponding virtual identities, such as for attendees joining the hybrid meeting virtually through a user device from the physical meeting space. Physical movement of attendees in and out of the physical meeting space during the hybrid meeting can be tracked, and associated mapping and merging of identities can be severed, re-mapped, and re-merged throughout the meeting, such as to maintain a roster of attendees of the hybrid meeting, provide a representation of the attendee to other meeting participants, or provide one or more other meeting services to respective attendees.

In one example, for a specific hybrid meeting, the first user 221 can be identified by the meeting service 210 or a component coupled to or accessible by the meeting service 210 through facial recognition as Attendee A, the second user 222 can be identified by the meeting service 210 or a component coupled to or accessible by the meeting service 210 through facial recognition as Attendee B, and the third user 223 can be identified by the meeting service 210 or a component coupled to or accessible by the meeting service 210 through connection of the third user device 233 as Attendee C. Attendees A and B are in-room attendees at the physical meeting space, detected by the camera 214 and confirmed by facial recognition. Attendee C is a virtual attendee remote from the physical meeting space and confirmed using a location of the third user device 233 and identified through the meeting application executed on the third user device 233 (e.g., logged in via username and password, biometrics, or combinations thereof). In addition to joining as an in-room attendee, Attendee B joins the hybrid meeting through the meeting application executed on the second user device 232, confirmed using a location of the second user device 232 and identified through the meeting application. Attendee A is logged into the meeting application executed on the first user device 231, but has not joined the hybrid meeting through the meeting application executed on the first user device 231. In this example, the meeting service 210 can automatically, upon identification of Attendee A as an in-room attendee in the physical meeting space and detecting connection of the meeting application executed on the first user device 231 to the meeting service 210 without having joined the hybrid meeting, send an instance of a message thread associated with the hybrid meeting to the meeting application executed on the first user device 231 of Attendee A, such that Attendee A can communicate in the message thread with the other attendees of the hybrid meeting without joining the hybrid meeting on the first user device 231.

In an example, the meeting service 210 can add the meeting application of the identified in-room attendee to the message thread associated with the hybrid meeting, and in certain examples, cause the message thread to be displayed in the meeting application on a display of the user device executing the meeting application. In certain examples, a notification can be displayed in a notification area of the meeting application, as a message in the meeting application, in a notification area of the user device executing the meeting application, or otherwise in a message (e.g., email, text message, etc.) to the identified in-room attendee.

Such addition of the identified in-room attendee to the message thread, without the meeting application joining the hybrid meeting, provides a number of technical benefits to the overall experience of all attendees of the hybrid meeting, increasing the immersive experience and communication abilities of the hybrid meeting, reducing redundant or otherwise difficult or impossible to recreate communication threads, but also provides technical benefits to the user device executing the meeting application, as joining the hybrid meeting on the user device generally requires additional processing, power, and data usage for the device. Instead connecting the device to the message thread, and not the presentation or video streams, replicates at least some communication benefits of being virtually connected to the hybrid meeting, without the associated device processing, power, and data costs of such connection.

In an example, Attendee A may be logged into a meeting application connected to the meeting service 210 executed on another user device, separate from the first user device 231, such as a desktop computer in an office separate or remote from the physical meeting space, or another user device in the physical meeting space. In certain examples, the meeting service 210 can distinguish between active and inactive user devices of specific attendees, such as using information from respective meeting applications or the user devices, and only send the instance of the message thread associated with the hybrid meeting to the meeting application (or otherwise cause a notification or display of the message thread, etc.) executed on the active user device during the hybrid meeting. In other examples, the meeting service 210 can send the instance of the message thread to active and inactive user devices (e.g., all identified attendees), but only cause a notification or display of the message thread to active user devices, such as to provide access to and encourage participation in the message thread of the hybrid meeting, without the increased data, processing, and power costs of joining the hybrid meeting, and without providing unnecessary notifications to inactive user devices. In yet other examples, if a specific user has multiple active devices, and a first device of the specific user has joined the hybrid meeting through the meeting application executed thereon, the meeting service 210 can selectively send or withhold the instance of the message thread to a second one or more of the remaining multiple active devices. In certain examples, the meeting service 210 can determine active devices of a specific user executing meeting applications connected to the meeting service 210, such as through respective meeting applications and user devices, and automatically provide a notification to the specific user, on respective one or more active devices executing the meeting application connected to the meeting service 210, to perform one or more of the following operations: selectively open the message thread on the respective active device; join the hybrid meeting on the respective active device; transfer the hybrid meeting from the first device to the respective active device; or dismiss the notification.

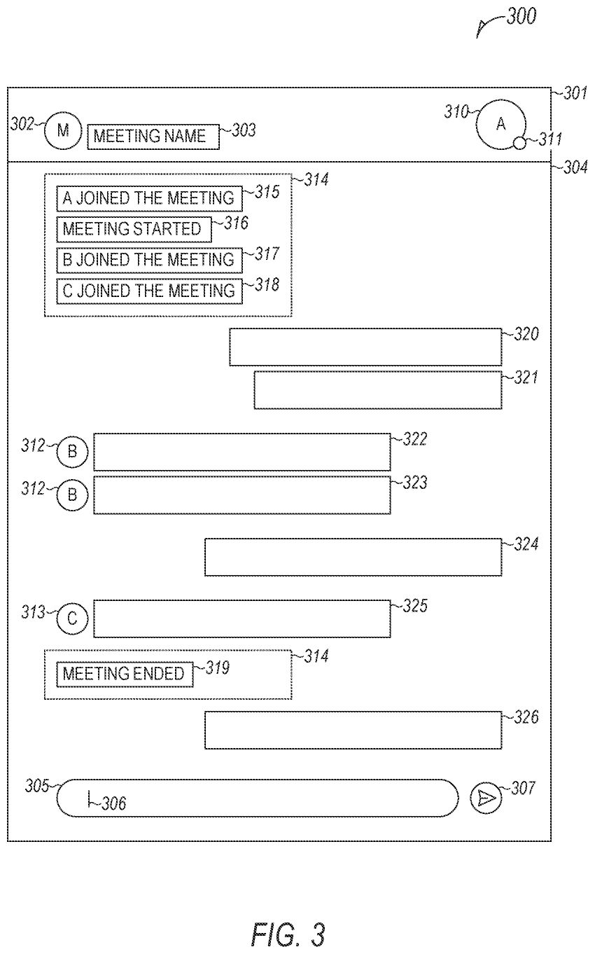

FIG. 3 illustrates an example message interface 300 on a meeting application executed on a user device of a first user, the message interface 300 illustrating a message thread between attendees of a hybrid meeting. The message interface 300 can include a header portion 301 having a number of configurable fields optionally identifying the group associated with the message thread and the first user, a body portion 304 including messages of the meeting thread and optionally meeting management fields 314, a compose field 305, an active cursor 306, and a send button 307.

The header portion 301 optionally includes a message identifier (e.g., an avatar “M”) 302, an associated meeting name 303, and identification of the first user. In this example, the first user is Attendee A. The identification of the first user can include a user identifier (e.g., an avatar “A”) 310, and optionally a status badge 311 indicating a current status of the first user (e.g., online, available, offline, unavailable, etc.).

The messages in the body portion 304 include right- and left-justified messages. The right-justified messages (e.g., messages 320, 321, 324, and 326) include messages of the first user, Attendee A, for example, entered in the compose field 305 and sent upon selection of the send button 307 or other send action or character. The left-justified messages (e.g., messages 322, 323, and 325) include messages of one or more other users of the message thread separate from the first user (e.g., Attendee B and Attendee C, identified by avatars “B” and “C” 312, 313, respectively, etc.). In this example, the first and second left-justified messages 322, 323 are messages of Attendee B, identified by the avatar “B” 312 to the left of the first and second left-justified messages 322, 323, and the third left-justified message 325 is a message of Attendee C, identified by the avatar “C” 313 to the left of the third left-justified message 325.

The optional meeting management fields 314 can indicate meeting actions or management activities, in certain examples by selectable links that perform other sorting or communication options and timestamped. For example, a first meeting management message 315 indicates that Attendee A joined the meeting, in certain examples, in chronological order. In certain examples, one or more of the message or the identifier (e.g., “A”) in the message, can be selectable by one or more users of the message thread, such as to provide one or more functions (e.g., send a private message to Attendee A, show the messages from Attendee A, show the time joined or left, provide transcript speaking portions of the meeting from Attendee A, add Attendee A to a sub-group separate from the message thread for the hybrid meeting, etc.). The second meeting management message 316 indicates that the meeting started. The third and fourth meeting management messages 317, 318 indicated that Attendees B and C joined the meeting. The fifth meeting management message 319 indicates that the meeting ended.

In an example, such as that described in FIG. 2, Attendee A can be the first user 221 identified by the meeting service 210, the conference system 211, or a component coupled to or accessible by the meeting service 210 as an in-room attendee of the hybrid meeting, having the meeting application executed on the first user device 231 of the first in-room attendee connected to the meeting service 210, without the meeting application executed on the first user device 231 having joined the hybrid meeting. Attendees B and C can be the second and third users 222, 223 each having joined the hybrid meeting through second and third user devices, 232, 233, respectively.

In certain examples, the message thread for the hybrid meeting can be accessed after the hybrid meeting has ended through the meeting application. In certain examples, all users registered for the meeting (e.g., having received an invitation and accepted, or only having been sent an invitation) have access to the message thread through the meeting application, regardless of having been identified by the conference system 211 or the meeting service 210 or having joined the hybrid meeting. In certain examples, unregistered users, once identified as an in-room attendee, can be added to the meeting roster, and can be sent an instance of the message thread associated with the hybrid meeting, without the unregistered user having joined the hybrid meeting on a meeting application connected to the meeting service 210, such as otherwise described herein. Once added to the message thread for the hybrid meeting, other meeting or messaging services will be available including the identified in-room attendee (e.g., other participants can message the identified in-room attendee, and the identified in-room attendee can message one or more other meeting participants or sub-groups of participants, without the identified in-room attendee having joined the hybrid meeting on a user device). In other examples, only users having joined the hybrid meeting or having been identified by the conference system 211 or the meeting service 210 have access to the message thread.

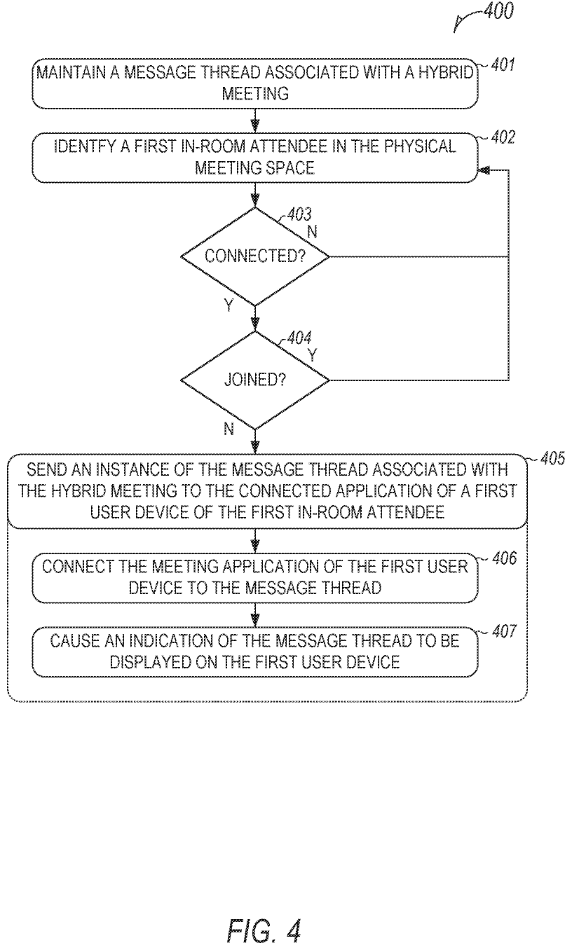

FIG. 4 illustrates an example method 400 for managing, using a meeting service, a message thread associated with a hybrid meeting, the hybrid meeting providing the capability for in-room attendance at a physical meeting space (e.g., a conference room) through a conference system and virtual attendance through one or more user devices executing a meeting application connected to the meeting service. The conference system, as described herein, can include one or more of a display configured to display presentation materials or, in certain examples, representations of one or more other meeting attendees of the hybrid meeting, and a camera configured to capture images of one or more in-room attendees at the physical meeting space, such as to identify the in-room attendees or provide representations of one or more of the in-room attendees to other participants of the hybrid meeting. The user devices include personal electronic devices of the in-room attendees or virtual attendees. In certain examples, meeting participants can be both in-room attendees and virtual attendees, attending the hybrid meeting in person at the physical meeting space and also joining the hybrid meeting through a meeting application executed connected to the meeting service on one or more user devices.

At step 401, a message thread can be maintained, using the meeting service, associated with the hybrid meeting. The message thread can be a chat thread accessible by one or more meeting participants through respective meeting applications, or one or more other communication threads, such as an email thread, a question/answer thread, side rooms to the hybrid meeting, or one or more other communication threads with various permissions managed by a meeting host or meeting rules established by administrators or meeting organizers, etc. In certain examples, the message thread can optionally or selectively accompany the hybrid meeting, and can optionally be used by meeting participants to contact other participants before, during, or after the scheduled time of the hybrid meeting.

At step 402, a first in-room attendee can be identified in the physical meeting space using one or more known techniques, such as facial recognition, device recognition, or location information. In an example, one or more of the meeting service or the conference system can receive identification of in-room attendees, such as from one or more other components of or associated with the meeting service, such as a facial recognition module configured to perform facial recognition of an image of the physical meeting space, a device recognition module configured to recognize user devices in or near the physical meeting space, or location information from a user device, such as through a meeting application connected to the meeting service, etc. In other examples, the meeting service or the conference system can perform identification of in-room attendees, such as by facial recognition, device recognition, or location information using one or more other known techniques.

The facial recognition or voice recognition described herein can include that described in the commonly assigned Thakkar et al. U.S. Patent Application 2009/0210491 “Techniques to Automatically Identify Participants for a Multimedia Conference Event,” herein incorporated by reference in its entirety, including its description of facial and voice recognition and mapping invited and detected participants. The device recognition described herein can include that described in the commonly assigned Krantz et al. U.S. Pat. No. 8,892,123 “Identifying Meeting Attendees Using Information from Devices,” herein incorporated by reference in its entirety, including its description of recognizing physical presence of a mobile device in proximity to a physical meeting place.

At step 403, after the first in-room attendee is identified, the meeting service can detect whether or not the first in-room attendee is logged in to a meeting application connected to the meeting service. If no connection is detected, process can return to step 401 or to step 402, such as to perform additional identification of one or more other in-room participants.

In certain examples, detecting whether the meeting application is connected can additionally include detecting that the device is connected and in an active state, in a location proximate the physical meeting space, or combinations thereof. For example, after connection is detected, the meeting service can determine whether or not the user device executing the connected meeting application is in an active or inactive state (e.g., having received user input within a recent time period, such as within several minutes, etc.), and require the user device to be determined in the active state to proceed. In certain examples, if the user device is determined to be in the inactive state, the meeting service can monitor the user device for transition to the active state before proceeding. In other examples, after connection is detected, the meeting service can determine a location of the user device. If the location of the user device is not at or near the physical meeting space (e.g., within a threshold distance, such as within tens of meters to account for variation in location determination, a short trip outside of the conference room, or moving out of the view of a camera in the physical meeting space, etc.), the in-room participant cannot use the user device to participate in the message thread (as the first in-room user has been identified at the physical meeting space), and process can return to step 401. In other examples, a combination of active state and location can be required to proceed, consistent with that described above.

At step 404, after connection is detected, the meeting service can detect whether or not the connected meeting application of the first in-room attendee has joined the hybrid meeting. If the meeting application of the first in-room attendee has joined the hybrid meeting, process can return to step 401 or to step 402, such as to perform additional identification of one or more other in-room participants, as an in-room attendee that has joined the hybrid meeting will have access to the message thread through the meeting application. However, for those not having joined, having access to the message thread without joining the hybrid meeting can provide a number of benefits, including reduced network and device resource costs, as well as benefits to the in-room attendee in communicating to the other meeting participants or viewing communication of the other meeting participants.

At step 405, an instance of the message thread associated with the hybrid meeting can be sent to the connected application of a first user device of the first in-room attendee. In certain examples, at step 406, the meeting application executed on the first user device can be connected to the message thread, without the meeting application joining the hybrid meeting. In other examples, at step 407, an indication of the message thread can be displayed on the first user device, prompting the first in-room attendee to participate.

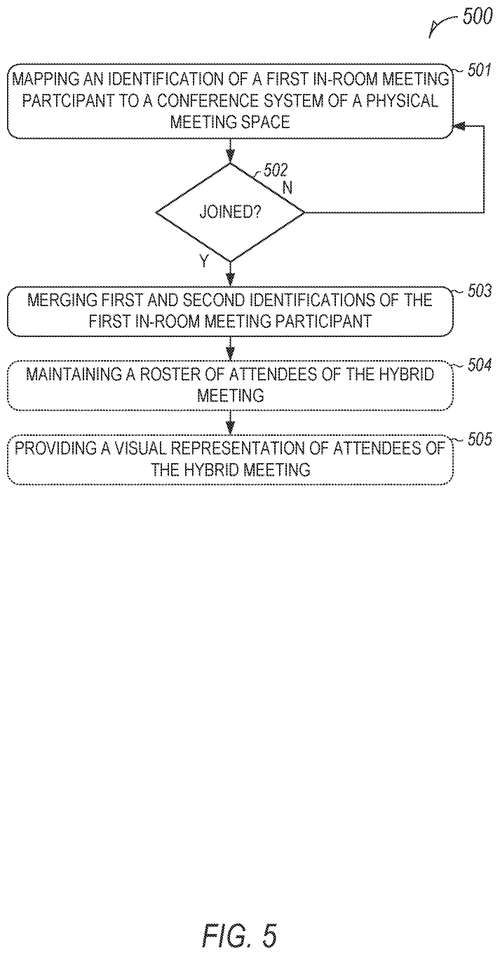

FIG. 5 illustrates an example method 500 of mapping in-room attendees to a physical meeting space and merging first and second identifications of an in-room attendee. For example, every participant joining the hybrid meeting through respective meeting applications executed on a user device can be identified and have a participant identification associated with the account logged into the meeting application. In certain examples, each registered user, having joined or not, can have a participant identification in the meeting. However, in-room attendees not having joined through a meeting application may not be properly managed by the meeting service, even once identified, such as by facial recognition, voice recognition, device recognition, or one or more other identifications, or may be assigned generic participant identification, providing potentially inaccurate meeting roster information, possibly under-reporting registered users attending or overreporting total attendance.

At step 501, an identification of a first in-room meeting participant can be mapped to a conference system, a component of a conference system, or to a physical meeting space, such as using a meeting service or the conference system, as a first identification. In an example, the first in-room meeting participant can be mapped to a physical meeting space. In other examples, the first in-room meeting participant can be mapped to a component of the conference system of the physical meeting space, such as to a specific camera, or to a specific camera view.

At step 502, the meeting service can detect whether or not the first in-room attendee has joined the hybrid meeting as a virtual attendee through a meeting application executed on a user device (e.g., logged into the meeting application as the first in-room attendee). If the meeting application of the first in-room attendee has not joined the hybrid meeting, or no active meeting application of the first in-room attendee is detected, process can end or return to step 501, such as to map one or more other identified in-room meeting participants to the physical meeting space.

At step 503, if the meeting application of the first in-room attendee has joined the hybrid meeting, a second identification associated with the virtual attendance can be merged into the first identification to create a single identification mapped to the conference system, the component of the conference system, or the physical meeting space, such as to accurately account for the single attendee having joined or attended the hybrid meeting in multiple ways.

At step 504, a roster of attendees of the hybrid meeting can be maintained, such as by the meeting service or the conference system. The roster, including attendees accurately mapped to the conference system, the component of the conference system, or the physical meeting space, can reduce creation and display of multiple representations of a single user for display during the hybrid meeting, reduce under- or over-reporting of attendance, assist in tagging meeting transcripts and accurately labeling chat messages and improving communication between meeting participants and management of attendee movement during the hybrid meeting.

At step 505, a visual representation of one or more attendees of the hybrid meeting can be provided, such as to one or more meeting participants, by the meeting service. Mapping and merging the multiple identifications of the same attendee from different points of attendance (e.g., in-room, virtual, or combinations of each), can reduce multiple representations of the same attendee, reducing overall system resources and providing a more immersive, seamless presentation environment.

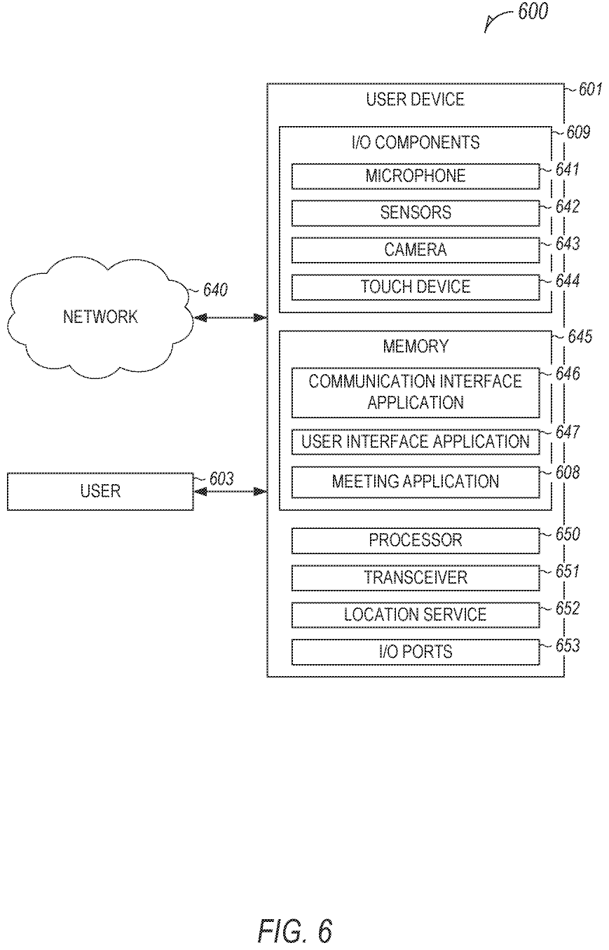

FIG. 6 illustrates an example system 600 including a user device 601 having one or more I/O components 609, a memory 645, a processor 650, a transceiver 651, a location service component 652, and one or more I/O ports 653. The user device 601 can take the form of a mobile computing device or any other portable device, such as a mobile telephone, laptop, tablet, computing pad, notebook, gaming device, portable media player, etc. In other examples, the user device 601 can include a less portable device, such as desktop personal computer, kiosk, tabletop device, industrial control device, etc. Other examples can incorporate the user device 601 as part of a multi-device system in which two separate physical devices share or otherwise provide access to the illustrated components of the user device 601.

The processor 650 can include any quantity of processing units and is programmed to execute computer-executable instructions for implementing aspects of the disclosure. The instructions may be performed by the processor or by multiple processors within the computing device or performed by a processor external to the user device 601. In some examples, the processor 650 is programmed to execute methods, such as the one or more method illustrated herein, etc. Additionally, or alternatively, the processor 650 can be programmed to present an experience in a user interface (“UI”), such as the user interface illustrated in FIGS. 2-3, etc. In certain examples, the processor 650 can represent an implementation of techniques to perform the operations described herein.

The transceiver 651 can include an antenna capable of transmitting and receiving radio frequency (“RF”) signals and various antenna and corresponding chipsets to provide communicative capabilities between the user device 601 and one or more other remote devices. Examples are not limited to RF signaling, however, as various other communication modalities may alternatively be used.

The I/O components 609 can include, without limitation, computer monitors, televisions, projectors, touch screens, phone displays, tablet displays, wearable device screens, televisions, speakers, vibrating devices, and any other devices configured to display, verbally communicate, or otherwise provide information visibly or audibly to a user 603 on the user device 601. For example, the user device 601 can include a desktop computer, a laptop computer, a smart phone, or a mobile tablet including speakers capable of displaying images or playing audio to the user 603. In other examples, the user device 601 can include a computer in a car that plays audio to the user 603 through a car speaker system, visually presents images on a display screens (e.g., situated in the car's dashboard, within headrests, on a drop-down screen, etc.), or combinations thereof. Other examples present the disclosed presentation material through various other display or audio I/O components 609.

The I/O components 609 can include one or more of a microphone 641, one or more sensors 642, a camera 643, or a touch device 644. The microphone 641 can capture speech from, by, about, or near the user 603. The sensors 642 can include any number of sensors on or in a mobile computing device, electronic toy, gaming console, wearable device, television, vehicle, or other user device 601, such as one or more of an accelerometer, magnetometer, pressure sensor, photometer, thermometer, global positioning system (“GPS”) chip or circuitry, bar scanner, biometric scanner for scanning fingerprint, palm print, blood, eye, or the like, gyroscope, near-field communication (“NFC”) receiver, or any other sensor configured to capture data from the user 603 or the environment. The camera 643 can capture images or video of or by the user 603. The touch device 644 can include a touchpad, track pad, touch screen, or other touch-capturing device. In other examples, the I/O components 609 can include one or more of a sound card, a vibrating device, a scanner, a printer, a wireless communication module, or any other component for capturing information related to the user 603 or the environment. In contrast, the I/O ports 653 allow the user device 601 to be logically coupled to other devices and I/O components 609, some of which may be built into user device 601 while others may be external.

The memory 645 can include any quantity of memory associated with or accessible by the user device 601. The memory 645 can be internal to the user device 601, external to the user device 601, or a combination thereof. The memory 645 can include, without limitation, random access memory (RAM), read only memory (ROM), electronically erasable programmable read only memory (EEPROM), flash memory or other memory technologies, CDROM, digital versatile disks (DVDs) or other optical or holographic media, magnetic cassettes, magnetic tape, magnetic disk storage or other magnetic storage devices, memory wired into an analog computing device, or any other medium for encoding desired information and for access by the user device 601. The terms computer-readable medium, machine readable medium, and storage device do not include carrier waves to the extent carrier waves are deemed too transitory. The memory 645 can take the form of volatile and/or nonvolatile memory, can be removable, non-removable, or a combination thereof; and can include various hardware devices, e.g., solid-state memory, hard drives, optical-disc drives, etc. Additionally, or alternatively, the memory 645 can be distributed across multiple user devices, such as the user device 601, such as in a virtualized environment in which instruction processing is carried out on multiple ones of the user device 601. The memory 645 can store, among other data, various device applications that, when executed by the processor 650, operate to perform functionality on the user device 601. Example applications can include search applications, instant messaging applications, electronic-mail application programs, web browsers, calendar application programs, address book application programs, messaging programs, media applications, location-based services, search programs, and the like. The applications may communicate with counterpart applications or services such as web services accessible via the network 640. For example, the applications can include client-operating applications that correspond to server-side applications executing on remote servers or computing devices in the cloud.

Instructions stored in the memory 645 can include, among other things, one or more of a communication interface application 646, a user interface application 647, and a meeting application 608. The communication interface application 646 can include one or more of computer-executable instructions for operating a network interface card and a driver for operating the network interface card. Communication between the user device 601 and other devices can occur using any protocol or mechanism over a wired or wireless connection or across the network 640. In some examples, the communication interface application 646 is operable with RF and short-range communication technologies using electronic tags, such as NFC tags, Bluetooth® brand tags, etc.

In some examples, the user interface application 647 includes a graphics application for displaying data to the user and receiving data from the user. The user interface application 647 can include computer-executable instructions for operating the graphics card to display search results and corresponding images or speech on or through one or more of the I/O components 609. The user interface application 647 can interact with the various sensors 642 and camera 643 to both capture and present information through the I/O components 609.

The location service component 652 can be configured to receive information from one or more of the sensors 642 or transceiver 651 and to determine a physical location of the user device 601. In certain examples, the location service component 652 can receive or determine the physical location using information from one or more wireless networks, including wired or wireless, long- or short-range communication access points, etc., using information from one or more GPS chip or circuitry, or combinations thereof.

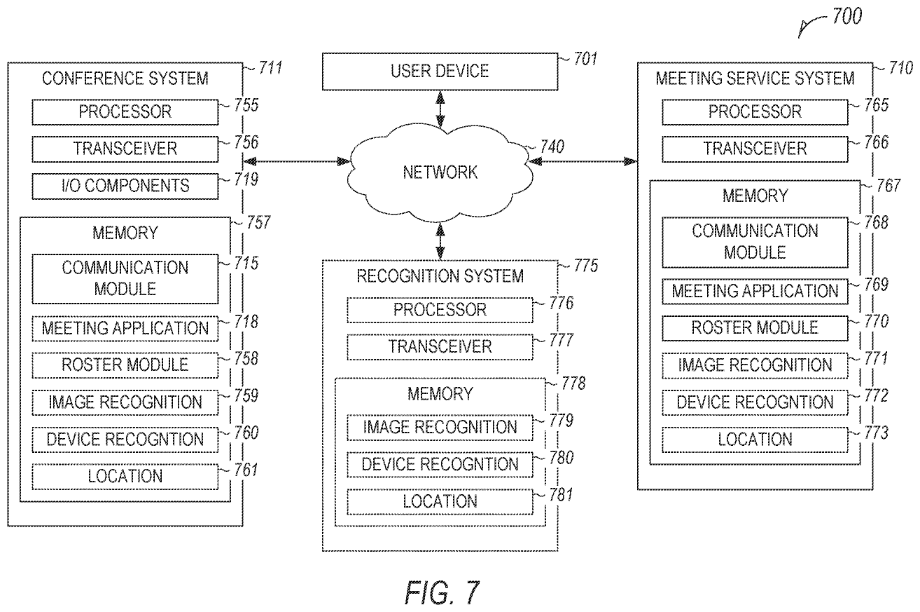

FIG. 7 illustrates an example networking environment 700 including one or more user devices, such as a user device 701, a meeting service system 710, a conference system 711, and a recognition system 775 communicating over a network 740. In some examples, images, device information, presentation material, and message threads are communicated between components of the example networking environment 700 over the network 740. In certain examples, the conference system 711 can facilitate presentation of a hybrid meeting in a physical meeting space, and provide images or other identifying information (e.g., voice, etc.) of one or more users in the physical meeting space to one or more of the meeting service system 710 or the recognition system 775 over the network 740, such as to facilitate identification of the in-room attendees of the hybrid meeting in the physical meeting space.

The networking environment 700 illustrated in FIG. 7 is an example of one suitable computing system environment and is not intended to suggest any limitation as to the scope of use or functionality of examples disclosed herein. The illustrated networking environment 700 should not be interpreted as having any dependency or requirement related to any single component, module, index, or combination thereof, and in other examples, other network environments are contemplated.

The network 740 can include the internet, a private network, a local area network (LAN), a wide area network (WAN), or any other computer network, including various network interfaces, adapters, modems, and other networking devices for communicatively connecting the user device 701, the conference system 711, and the meeting service system 710. The network 740 can also include configurations for point-to-point connections.

The user device 701 include any type of user device discussed herein. Each user device 701 can capture user or environment data from their respective users and communicate the captured user and environment data over the network 740 to the conference system 711, the meeting service system 710, or both, such as using a communications module or transceiver, as discussed herein. In response, the communications module can be capable of providing and receiving messages including images, videos, audio, text, and other various communication media to and from user device 701 over the network 740.

The user device 701 can include various software applications and presentation components for communicating via a message thread associated with respective hybrid meetings attended by the user of the user device 701. For example, a mobile phone can display a communication platform (e.g., Microsoft Teams application) for communicating with other attendees of a hybrid meeting.

The conference system 711 can be a physical device configured to present and manage a hybrid meeting in the physical meeting place, such as a conference room, etc., as well as facilitate identification of in-room attendees, such as using one or more U/O components 719, such as a camera, etc. The conference system 711 includes a processor 755 to process executable instructions, a transceiver 756 to communicate over the network 740, and a memory 757 embodied with at least the following executable instructions: a communication module 715, a meeting application 718, a roster module 758, an image recognition module 759, a device recognition module 760, a location module 761, or one or more other modules, such as a triggering module, an audio module, etc. In certain examples, the conference system 711 can include a user device configured to present and manage the hybrid meeting for one or more in-room meeting participants.

The meeting service system 710 can include a server or collection of servers configured to execute different web-service computer-executable instructions. The meeting service system 710 includes a processor 765 to process executable instructions, a transceiver 766 to communicate over the network 740, and a memory 767 embodied with at least the following executable instructions: a communication module 768, a meeting application 769, a roster module 770, an image recognition module 771, a device recognition module 772, a location module 773, or one or more other modules, etc. While the communication module 768 is illustrated as a single box, it is not so limited, and can be scalable. For example, the communication module 768 can include multiple servers operating various portions of software that collectively manage a hybrid meeting environment.

The recognition system 775 can provide information about one or more users that can be accessed over the network 740 by the conference system 711 or the meeting service system 710 to assist in identification of one or more in-room attendees of a hybrid meeting, such as via facial recognition, voice recognition, or device information. The recognition system 775 includes a processor 776 to process executable instructions, a transceiver 776 to communicate over the network 740, and a memory 778 embodied with at least the following executable instructions: an image recognition module 779, a device recognition module 780, a location module 781, or one or more other modules. Also, networking environment 700 depicts the recognition system 775 as a collection of separate devices from the meeting service system 710 or the conference system 711, however, examples can actually perform identification functions and access user data on or through one or more of the meeting service system 710, the conference system 711, or the user device 701, etc.

Herein, a “user profile” refers to an electronically stored collection of information related to the user. Such information can be stored based on a user's explicit agreement or “opt-in” to having such personal information be stored, the information including the user's name, age, gender, height, weight, demographics, current location, residency, citizenship, family, friends, schooling, occupation, hobbies, skills, interests, Web searches, health information, birthday, anniversary, celebrated holidays, moods, user condition, and any other personalized information associated with the user, including biometric information, or information enabling identification of specific in-room attendees. The user profile includes static profile elements, e.g., name, birthplace, etc., and dynamic profile elements that change over time, e.g., residency, age, condition, etc. The user profile can be built through probing questions to the user or through analyzing user behavior on one or more user devices.

The present disclosure relates to systems and methods for managing in-room meeting participants of a hybrid meeting according to at least the examples provided in the sections below:
(A1) In one aspect, some embodiments or examples include a system for managing a message thread associated with a hybrid meeting, the hybrid meeting providing a capability for in-room attendance at a physical meeting space through a conference system and virtual attendance through one or more user devices, comprising one or more processors and a memory storing computer-executable instructions that, when executed, cause the one or more processors to control the system to perform operations comprising: maintaining the message thread associated with the hybrid meeting; identifying a first in-room attendee in the physical meeting space; detecting connection of a meeting application executed on a first user device of the first in-room attendee to a meeting service, without the meeting application having joined the hybrid meeting; and in response to identifying the first in-room attendee in the physical meeting space and detecting connection of the meeting application executed on the first user device of the first in-room attendee to the meeting service, without the meeting application having joined the hybrid meeting, sending an instance of the message thread associated with the hybrid meeting to the meeting application executed on the first user device of the first in-room attendee.
(A2) In some embodiments of A1, sending the instance of the message thread associated with the hybrid meeting comprises connecting the meeting application executed on the first user device of the first in-room attendee to the message thread associated with the hybrid meeting to provide the first in-room attendee access to communicate in the message thread without joining the hybrid meeting on the first user device and causing the message thread, or a notification of the message thread, to be displayed on the first user device.
(A3) In some embodiments of A1-A2, identifying the first in-room attendee in the physical meeting space comprises determining that a location of the first user device the first in-room attendee is at the physical meeting space.
(A4) In some embodiments of A1-A3, the operations further comprise capturing an image of the physical meeting space using a camera of the conference system at the physical meeting space, wherein identifying the first in-room attendee in the physical meeting space comprises identifying the first in-room attendee in the physical meeting space using facial recognition of the captured image of the physical meeting space.
(A5) In some embodiments of A1-A4, detecting connection of the meeting application executed on the first user device of the first in-room attendee to the meeting service, without the meeting application having joined the hybrid meeting, comprises determining that the hybrid meeting has started and determining that the meeting application executed on the first user device has not joined the hybrid meeting on the first user device.
(A6) In some embodiments of A1-A5, the operations further comprise assigning a first identification to the identified first in-room attendee and mapping the first identification of the first in-room attendee to the conference system in the physical meeting space.
(A7) In some embodiments of A1-A6, the operations further comprise detecting connection of a second meeting application executed on a second user device of the first in-room attendee to the meeting service having joined the hybrid meeting and in response to the detected connection of the second meeting application having joined the hybrid meeting, merging an identify of the second meeting application of the first in-room attendee with the mapped first identification to the conference system in the physical meeting space.
(A8) In some embodiments of A1-A7, the operations further comprise maintaining a roster of attendees of the hybrid meeting using the merged identity and providing a visual representation of first in-room attendee and other attendees of the hybrid meeting using the maintained roster of attendees.
(B1) In one aspect, some embodiments or examples include a method for managing, using a meeting service, a message thread associated with a hybrid meeting, the hybrid meeting providing a capability for in-room attendance at a physical meeting space through a conference system and virtual attendance through one or more user devices, the method comprising maintaining the message thread associated with the hybrid meeting identifying a first in-room attendee in the physical meeting space, detecting connection of a meeting application executed on a first user device of the first in-room attendee to the meeting service, without the meeting application having joined the hybrid meeting, and in response to identifying the first in-room attendee in the physical meeting space and detecting connection of the meeting application executed on the first user device of the first in-room attendee to the meeting service, without the meeting application having joined the hybrid meeting, sending an instance of the message thread associated with the hybrid meeting to the meeting application executed on the first user device of the first in-room attendee.
(B2) In some embodiments of B1, sending the instance of the message thread associated with the hybrid meeting comprises connecting the meeting application executed on the first user device of the first in-room attendee to the message thread associated with the hybrid meeting to provide the first in-room attendee access to communicate in the message thread without joining the hybrid meeting on the first user device and causing the message thread, or a notification of the message thread, to be displayed on the first user device.
(B3) In some embodiments of B1-B2, identifying the first in-room attendee in the physical meeting space comprises determining that a location of the first user device the first in-room attendee is at the physical meeting space.
(B4) In some embodiments of B1-B3, capturing an image of the physical meeting space using a camera of the conference system at the physical meeting space, wherein identifying the first in-room attendee in the physical meeting space comprises identifying the first in-room attendee in the physical meeting space using facial recognition of the captured image of the physical meeting space.
(B5) In some embodiments of B1-B4, detecting connection of the meeting application executed on the first user device of the first in-room attendee to the meeting service, without the meeting application having joined the hybrid meeting, comprises determining that the hybrid meeting has started and determining that the meeting application executed on the first user device has not joined the hybrid meeting on the first user device.
(B6) In some embodiments of B1-B5, the method further comprises assigning a first identification to the identified first in-room attendee and mapping the first identification of the first in-room attendee to the conference system in the physical meeting space.
(B7) In some embodiments of B1-B6, the method further comprises detecting connection of a second meeting application executed on a second user device of the first in-room attendee to the meeting service having joined the hybrid meeting and in response to the detected connection of the second meeting application having joined the hybrid meeting, merging an identify of the second meeting application of the first in-room attendee with the mapped first identification to the conference system in the physical meeting space.
(B8) In some embodiments of B1-B7, the method further comprises maintaining a roster of attendees of the hybrid meeting using the merged identity and providing a visual representation of first in-room attendee and other attendees of the hybrid meeting using the maintained roster of attendees.
(C1) In one aspect, some embodiments or examples include a system for managing a message thread associated with a hybrid meeting, the hybrid meeting providing a capability for in-room attendance at a physical meeting space and virtual attendance remote from the physical meeting space, comprising means for maintaining the message thread associated with the hybrid meeting, means for identifying a first in-room attendee in the physical meeting space, means for detecting connection of a meeting application executed on a first user device of the first in-room attendee to a meeting service, without the meeting application having joined the hybrid meeting, and means for sending, in response to identifying the first in-room attendee in the physical meeting space and detecting connection of the meeting application executed on the first user device of the first in-room attendee to the meeting service, without the meeting application having joined the hybrid meeting, an instance of the message thread associated with the hybrid meeting to the meeting application executed on the first user device of the first in-room attendee.
(C2) In some embodiments of C1, the means for sending the instance of the message thread associated with the hybrid meeting comprises means for connecting the meeting application executed on the first user device of the first in-room attendee to the message thread associated with the hybrid meeting to provide the first in-room attendee access to communicate in the message thread without joining the hybrid meeting on the first user device and means for causing the message thread, or a notification of the message thread, to be displayed on the first user device.
(C3) In some embodiments of C1-C2, the means for identifying the first in-room attendee in the physical meeting space comprises means for determining that a location of the first user device the first in-room attendee is at the physical meeting space.
(C4) In some embodiments of C1-C3, the system comprises means for capturing an image of the physical meeting space, wherein the means for identifying the first in-room attendee in the physical meeting space comprises means for identifying the first in-room attendee in the physical meeting space using facial recognition of the captured image of the physical meeting space.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

In the description herein, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical, and electrical changes may be made without departing from the scope of the present invention. The included description of example embodiments is, therefore, not to be taken in a limited sense, and the scope of the present invention is defined by the appended claims.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

What is claimed is:

1. A system for managing a message thread associated with a hybrid meeting, the hybrid meeting providing a capability for in-room attendance at a physical meeting space through a conference system and virtual attendance through one or more user devices, comprising:
one or more processors; and
a memory storing computer-executable instructions that, when executed, cause the one or more processors to control the system to perform operations comprising:
maintaining the message thread associated with the hybrid meeting;
identifying a first in-room attendee in the physical meeting space;
detecting connection of a meeting application executed on a first user device of the first in-room attendee to a meeting service, without the meeting application having joined the hybrid meeting; and
in response to identifying the first in-room attendee in the physical meeting space and detecting connection of the meeting application executed on the first user device of the first in-room attendee to the meeting service, without the meeting application having joined the hybrid meeting, sending an instance of the message thread associated with the hybrid meeting to the meeting application executed on the first user device of the first in-room attendee.

2. The system of claim 1, wherein sending the instance of the message thread associated with the hybrid meeting comprises:
connecting the meeting application executed on the first user device of the first in-room attendee to the message thread associated with the hybrid meeting to provide the first in-room attendee access to communicate in the message thread without joining the hybrid meeting on the first user device; and
causing the message thread, or a notification of the message thread, to be displayed on the first user device.

3. The system of claim 1, wherein identifying the first in-room attendee in the physical meeting space comprises:
determining that a location of the first user device the first in-room attendee is at the physical meeting space.

4. The system of claim 1, wherein the operations further comprise:
capturing an image of the physical meeting space using a camera of the conference system at the physical meeting space,
wherein identifying the first in-room attendee in the physical meeting space comprises:
identifying the first in-room attendee in the physical meeting space using facial recognition of the captured image of the physical meeting space.

5. The system of claim 1, wherein detecting connection of the meeting application executed on the first user device of the first in-room attendee to the meeting service, without the meeting application having joined the hybrid meeting, comprises:
determining that the hybrid meeting has started; and
determining that the meeting application executed on the first user device has not joined the hybrid meeting on the first user device.

6. The system of claim 1, wherein the operations further comprise:
assigning a first identification to the identified first in-room attendee; and
mapping the first identification of the first in-room attendee to the conference system in the physical meeting space.

7. The system of claim 6, wherein the operations further comprise:
detecting connection of a second meeting application executed on a second user device of the first in-room attendee to the meeting service having joined the hybrid meeting; and
in response to the detected connection of the second meeting application having joined the hybrid meeting, merging an identify of the second meeting application of the first in-room attendee with the mapped first identification to the conference system in the physical meeting space.

8. The system of claim 7, wherein the operations further comprise:
maintaining a roster of attendees of the hybrid meeting using the merged identity; and
providing a visual representation of first in-room attendee and other attendees of the hybrid meeting using the maintained roster of attendees.

9. A method for managing, using a meeting service, a message thread associated with a hybrid meeting, the hybrid meeting providing a capability for in-room attendance at a physical meeting space through a conference system and virtual attendance through one or more user devices, the method comprising:
maintaining the message thread associated with the hybrid meeting;
identifying a first in-room attendee in the physical meeting space;
detecting connection of a meeting application executed on a first user device of the first in-room attendee to the meeting service, without the meeting application having joined the hybrid meeting; and
in response to identifying the first in-room attendee in the physical meeting space and detecting connection of the meeting application executed on the first user device of the first in-room attendee to the meeting service, without the meeting application having joined the hybrid meeting, sending an instance of the message thread associated with the hybrid meeting to the meeting application executed on the first user device of the first in-room attendee.

10. The method of claim 9, wherein sending the instance of the message thread associated with the hybrid meeting comprises:
connecting the meeting application executed on the first user device of the first in-room attendee to the message thread associated with the hybrid meeting to provide the first in-room attendee access to communicate in the message thread without joining the hybrid meeting on the first user device; and
causing the message thread, or a notification of the message thread, to be displayed on the first user device.

11. The method of claim 9, wherein identifying the first in-room attendee in the physical meeting space comprises:
determining that a location of the first user device the first in-room attendee is at the physical meeting space.

12. The method of claim 9, comprising:
capturing an image of the physical meeting space using a camera of the conference system at the physical meeting space,
wherein identifying the first in-room attendee in the physical meeting space comprises:
identifying the first in-room attendee in the physical meeting space using facial recognition of the captured image of the physical meeting space.

13. The method of claim 9, wherein detecting connection of the meeting application executed on the first user device of the first in-room attendee to the meeting service, without the meeting application having joined the hybrid meeting, comprises:
determining that the hybrid meeting has started; and
determining that the meeting application executed on the first user device has not joined the hybrid meeting on the first user device.

14. The method of claim 9, wherein the method further comprises:
assigning a first identification to the identified first in-room attendee; and
mapping the first identification of the first in-room attendee to the conference system in the physical meeting space.

15. The method of claim 14, wherein the method further comprises:
detecting connection of a second meeting application executed on a second user device of the first in-room attendee to the meeting service having joined the hybrid meeting; and
in response to the detected connection of the second meeting application having joined the hybrid meeting, merging an identify of the second meeting application of the first in-room attendee with the mapped first identification to the conference system in the physical meeting space.

16. The method of claim 15, wherein the method further comprises:
maintaining a roster of attendees of the hybrid meeting using the merged identity; and
providing a visual representation of first in-room attendee and other attendees of the hybrid meeting using the maintained roster of attendees.

17. A system for managing a message thread associated with a hybrid meeting, the hybrid meeting providing a capability for in-room attendance at a physical meeting space and virtual attendance remote from the physical meeting space, comprising:
means for maintaining the message thread associated with the hybrid meeting;
means for identifying a first in-room attendee in the physical meeting space;
means for detecting connection of a meeting application executed on a first user device of the first in-room attendee to a meeting service, without the meeting application having joined the hybrid meeting; and
means for sending, in response to identifying the first in-room attendee in the physical meeting space and detecting connection of the meeting application executed on the first user device of the first in-room attendee to the meeting service, without the meeting application having joined the hybrid meeting, an instance of the message thread associated with the hybrid meeting to the meeting application executed on the first user device of the first in-room attendee.

18. The system of claim 17, wherein the means for sending the instance of the message thread associated with the hybrid meeting comprises:
means for connecting the meeting application executed on the first user device of the first in-room attendee to the message thread associated with the hybrid meeting to provide the first in-room attendee access to communicate in the message thread without joining the hybrid meeting on the first user device; and
means for causing the message thread, or a notification of the message thread, to be displayed on the first user device.

19. The system of claim 17, wherein the means for identifying the first in-room attendee in the physical meeting space comprises:
means for determining that a location of the first user device the first in-room attendee is at the physical meeting space.

20. The system of claim 17, comprising:
means for capturing an image of the physical meeting space,
wherein the means for identifying the first in-room attendee in the physical meeting space comprises:
means for identifying the first in-room attendee in the physical meeting space using facial recognition of the captured image of the physical meeting space.
